(19) United States
(12) Patent Application Publication
(10) Pub. No.: US 2018/0096525 A1
(43) Pub. Date: Apr. 5, 2018

(54) METHOD FOR GENERATING AN ORDERED POINT CLOUD USING MOBILE SCANNING DATA

(71) Applicant: INDOOR REALITY INC., Berkeley, CA (US)

(72) Inventors: Eric Lee Turner, Berkeley, CA (US); Ivana Stojanovic, Berkeley, CA (US)

(21) Appl. No.: 15/820,382

(22) Filed: Nov. 21, 2017

Related U.S. Application Data
(63) Continuation of application No. 15/095,088, filed on Apr. 10, 2016, now abandoned.
(60) Provisional application No. 62/306,968, filed on Mar. 11, 2016.

(51) Int. Cl. G06T 17/20; G06T 15/06; G06T 19/20

(52) U.S. Cl. CPC G06T 17/20; G06T 2207/10028; G06T 2210/04; G06T 2219/2012; G06T 2207/30244; G06T 7/0044; G06T 15/06; G06T 19/20

(57) ABSTRACT

Methods for generating a set of ordered point clouds using a mobile scanning device are presented, the method including: causing the mobile scanning device to perform a walkthrough scan of an interior building space; storing data scanned during the walkthrough; creating a 3-dimensional (3D) mesh from the scanned data; and creating the set of ordered point clouds aligned to the 3D mesh, where the creating the set of ordered point clouds aligned to the 3D mesh includes, aligning a number of scanned points with the 3D mesh, performing in parallel the steps of, coloring each of a number of scanned points, calculating a depth of each of the number of scanned points, and calculating a normal of each of the number of scanned points.

### BACKGROUND

Static scanning stations typically generate dense 3-dimensional (3D) point cloud information taken from a single scanning location. This process allows the recovered data to be represented as a high-density 3D point cloud with color, or as a panoramic color image with 3D depth information associated with each pixel. The resulting data product is often referred to as an “ordered” point cloud, since the scans are taken in a grid-pattern, scanning rows and columns as the sensor rotates around to capture the environment.

Mobile scanning solutions, on the other hand, typically generate much sparser point clouds, oftentimes too sparse to be useful in effective visualization. Since the scanning device is constantly moving throughout the environment, the sensors do not stay at a single location long enough to get the level of density generated by a static scan station. Additionally, the resulting point clouds from a mobile scanner are natively “unordered”, since the order of the points is determined by how the scanner was moved through the environment, and is not on a regular grid-like pattern. In addition, mobile scanning devices produce point clouds that are not only sparse, but are also much noisier and in addition may have scanning holes.

As such, methods for generating an ordered point cloud using a mobile scanner data are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such, methods for generating a set of ordered point clouds using a mobile scanning device are presented, the method including: causing the mobile scanning device to perform a walkthrough scan of an interior building space; storing data scanned during the walkthrough; creating a 3-dimensional (3D) mesh from the scanned data; and creating the set of ordered point clouds aligned to the 3D mesh, where the creating the set of ordered point clouds aligned to the 3D mesh includes, aligning a number of scanned points with the 3D mesh, performing in parallel the steps of, coloring each of a number of scanned points, calculating a depth of each of the number of scanned points, and calculating a normal of each of the number of scanned points. In some embodiments, the mobile scanning device captures one or more of the following: a number of images from a number of camera positions, pose and orientation information associated with each of the number of images captured, and magnetic data information associated with each of the number of images captured. In some embodiments, methods further include: continuing to iteratively perform the steps of aligning, coloring, calculating the depth, and calculating the normal of the number of scanned points until a specified density is achieved. In some embodiments, the coloring the number of scanned points further includes: selecting a number of images temporally proximate with the scan position; determining a 3D world position/orientation of a cameras associated with the selected images; projecting the ray traced point onto an image plane of the camera for each of the selected images; discarding any occluded images; assigning a quality metric to a point in the image plane of the camera; selecting a nearest color of the projected ray traced point from the selected images; and assigning all nearest colors of all non-discarded images. In some embodiments, assigning the selected color further includes: if the nearest color from each of the number of are substantially similar, selecting the color; and if the nearest color from each of the number of are different, computing a weighted average of the colors and selecting the color from the weighted average. In some embodiments, the quality metric is combination of factors selected from the group consisting of: a factor inversely proportional to the pixel distortion, a factor inversely proportional to an amount of pixel blur, a factor inversely proportional to operator velocity at the time of image taking, and a factor inversely proportional to a point distance to camera.

In other embodiments, computing device program products for generating a set of ordered point clouds using a mobile scanning device are presented, the computing device program product including: a non-transitory computer readable medium; first programmatic instructions for storing data scanned during a walkthrough scan of an interior building space; second programmatic instructions for creating a 3D mesh from the scanned data; and third programmatic instructions for creating the set of ordered point clouds aligned to the 3D mesh, where the third programmatic instructions include, aligning a number of scanned points with the 3D mesh, performing in parallel the steps of, coloring each of a number of scanned points, calculating a depth of each of the number of scanned points, and calculating a normal of each of the number of scanned points, and where the programmatic instructions are stored on the non-transitory computer readable medium. In some embodiments, the fifth programmatic instructions for coloring the number of scanned points further includes: eleventh programmatic instructions for selecting a number of images temporally proximate with the scan position; twelfth programmatic instructions for determining a 3D world position/orientation of a cameras associated with the selected images; thirteenth programmatic instructions for projecting the ray traced point onto an image plane of the camera for each of the selected images; fourteenth programmatic instructions for discarding any occluded images; fifteenth programmatic instructions for assigning a quality metric to a point in the image plane of the camera; sixteenth programmatic instructions for selecting a nearest color of the projected ray traced point from the selected images; and seventeenth programmatic instructions for assigning all nearest colors of all non-discarded images.

### BRIEF DESCRIPTION OF THE DRAWINGS

FIG. 1 is an illustrative flowchart of methods for generating an ordered point cloud using a mobile scanner data in accordance with embodiments of the present invention;

FIG. 2 is an illustrative flowchart of methods for generating an aligning and coloring a point in a point cloud using a mobile scanner data in accordance with embodiments of the present invention;

FIG. 3 is an illustrative representation of a low density point cloud generated utilizing methods in accordance with embodiments of the present invention;

FIG. 4 is an illustrative representation of a high density point cloud generated utilizing methods in accordance with embodiments of the present invention;

FIG. 5 is an illustrative representation of a triangulated mesh generated utilizing methods in accordance with embodiments of the present invention;

FIG. 6 is an illustrative flowchart of methods for generating an aligning and coloring a point in a point cloud using a mobile scanner data in accordance with embodiments of the present invention;

FIG. 7 is an illustrative flowchart of methods for assigning a color to 3D point in accordance with embodiments of the present invention;

FIG. 8 is an illustrative flowchart of methods for assigning a distance from a 3D point to the scan center location in accordance with embodiments of the present invention;

FIG. 9 is an illustrative flowchart of methods for assigning a surface normal to a 3D point in accordance with embodiments of the present invention;

FIG. 10 is an illustrative flowchart of methods for making real-world 3D measurement from 360° panoramic image associated with an ordered point cloud in accordance with embodiments of the present invention; and

FIG. 11 is an illustrative flowchart of methods for asset tagging in all color panoramic images associated with ordered point clouds.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

As will be appreciated by one skilled in the art, the present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer readable storage medium, as used herein, is not to be construed as being transitory signals /per se/, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Mobile scanning devices produce point clouds that are not only sparse, but are also much noisier and, in addition, may have scanning holes. In the process of up-sampling and generating ordered point clouds, the scanning holes are filled (missing information is interpolated) and the point cloud is cleaned from noise. This step is necessary for enabling 3D measurements from imagery, as described below.

Oftentimes, mobile scanning devices accumulate small uncertainties in an operator path, leading to inaccurate 3D point locations in a world coordinate system. If an area is scanned multiple times with significant time gaps between revisits, accumulated and non-corrected path errors manifest themselves as point cloud's ghost or double surfaces. Such double surfaces are effectively removed from an ordered point cloud by creating 3D mesh and then utilizing this mesh in the ordered point cloud generation process.

For effective visualization of spaces scanned with mobile scanning devices, sparse point clouds need to be up sampled to dense 3D point clouds, which then can be colored with any 3D point attribute, such as, but not limited to: color, normal of the underlying surface, depth information, height above ground, time of acquisition, etc. Furthermore, a pixel in panoramic color image flat 2D representation can be associated with a set of 3D pixel attributes. 3D pixel attributes may include, but not limited to: depth information, normal of the underlying surface, quality metric of a pixel.

An ordered point cloud associated with a single panoramic image is then used for enabling 3D measurements directly on panoramic images: (a) a user clicks on a two pixels in a panoramic image, e.g. two corners of a window, (b) both pixels' depth information is retrieved and converted into their 3D positions in the world coordinate system, (c) a length of an object is then calculated

An ordered point cloud associated with a single panoramic image is then used for enabling 3D asset tagging directly on panoramic images: (a) user clicks on pixel in a panorama, and (b) a 3D point location in the master point cloud is found, and (c) a 3D avatar of that asset is then inserted into the master point cloud, or (d) a 3D asset location is saved in the database, along with an annotation that can be, but not limited to, an image, an audio note, etc. Such 3D annotation database can then be viewed in 3D or in a virtual walk-through. Thus, a user tags an object once, but sees it in all panoramic images that contain it during the virtual walk-through.

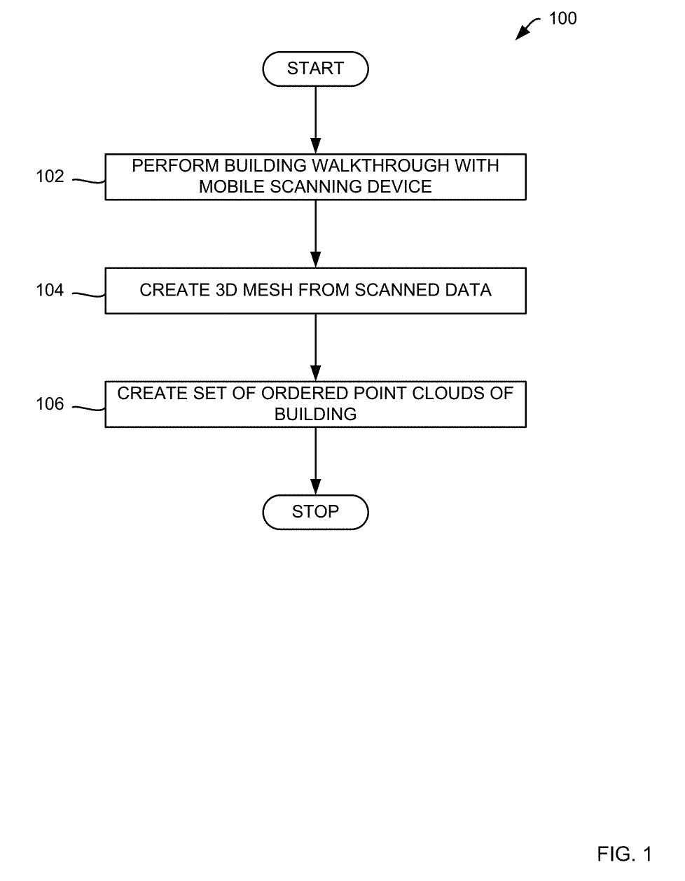

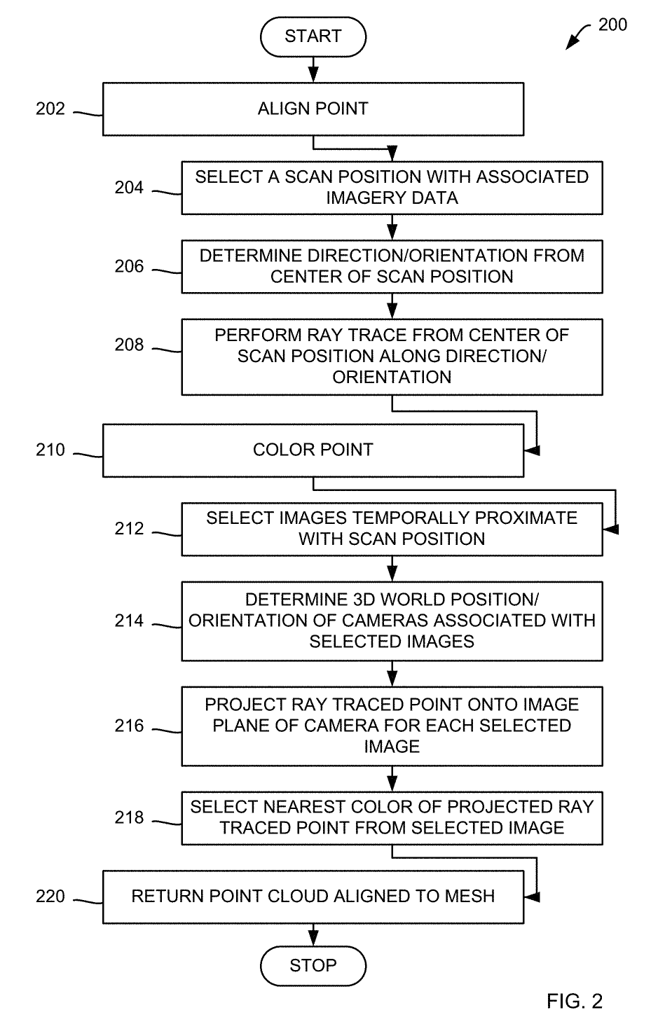

FIG. 1 is an illustrative flowchart 100 of methods for generating an ordered point cloud using mobile scanner data in accordance with embodiments of the present invention. In general, methods herein are presented for emulating high-density, ordered 3D imaging data of a static scanner and derived from the data of a mobile scanner (unsorted, sparse point cloud). As such, at a step 102, the method performs a building walkthrough with a mobile scanning device. As contemplated herein, a mobile scanning device is capable of capturing one or more of the following: images from multiple positions, pose and orientation information associated each image captured, magnetic data information associated each image captured, and any other electronic or thermal waveform information associated with each image captures. At a next step 104, the method creates a 3D mesh from the unordered and sparse scanned data and images. Any type of meshing technique known in the art will suffice so long as the 3D mesh is “watertight.” One example of a watertight triangulated 3D mesh is illustrated in FIG. 5. Returning to FIG. 1, at a next step 106, the method creates a set of ordered point clouds of the building. Step 106 will be discussed in further detail below for FIG. 2.

FIG. 2 is an illustrative flowchart 200 of methods for generating an aligning and coloring a point in a point cloud using mobile scanner data in accordance with embodiments of the present invention. In particular, FIG. 2 further describes a step 106 of FIG. 1. At a first step 202, the methods aligns a plurality of scanned points with the mesh generated. A step 202 corresponds with at least three sub-steps 204 to 208. At a step 204, the method selects a scan position having associated imagery data. Utilizing methods disclosed herein, the scan position selected must have imagery data associated with it. A mobile scanning system generally includes several cameras with each camera capturing images substantially continuously or at some pre-determined interval. When a scan position at which to generate a local ordered point cloud is selected, images that are temporally proximate with the scan position from each of a number of cameras on the mobile scanning device are selected for analysis. For example, one system includes several cameras having different views namely: back, left, right, front, top. One reason for using multiple cameras is to generate a local point cloud that has information at every angle. Thus, all cameras available may be utilized for each scan position. In other embodiments, it may be be possible to only use a subset of the cameras, but this would mean that there would be areas of the resulting point cloud that are uncolored. In embodiments, these cameras may be configured to capture images at substantially the same time although actual images may be captured a few milliseconds apart. For a selected scan position, the method may include at least five images: a nearest in time back-camera image, a nearest in time right-camera image, a nearest in time left-camera image, a nearest in time front-camera image, and a nearest in time top-camera image. In practice, a scan position represents a point along the building walkthrough. A timestamp is determined for that point. The images from each camera nearest to that timestamp are selected so that the resulting merged image is consistent. It may be desirable to select images taken as close together in time as possible since a scene might change over time (people walking by, doors opening, etc.).

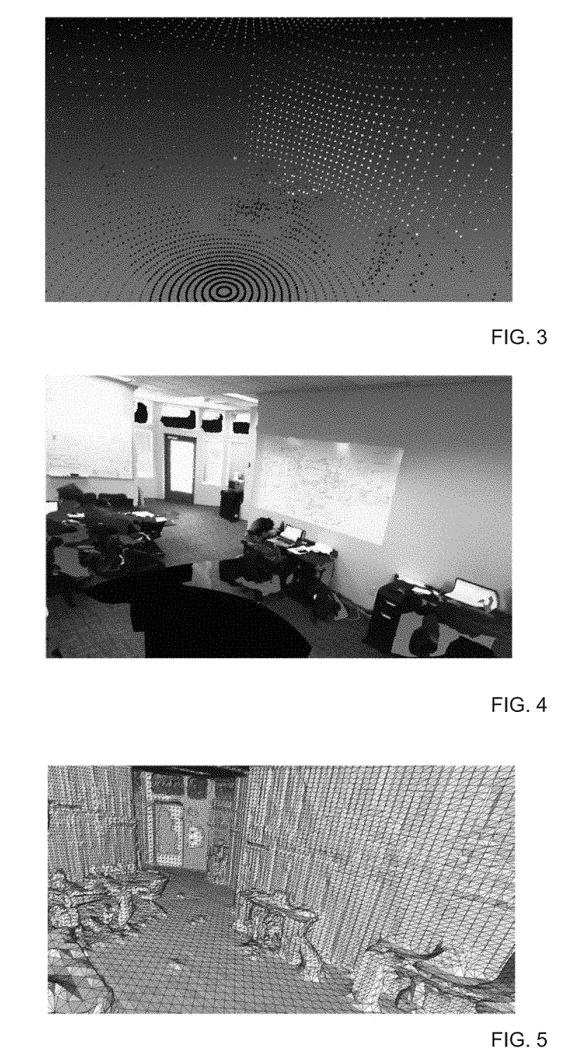

At a next step 206, the method determines the direction/orientation from the center of the scan position. Using the generated 3D mesh and the imagery from the scan position selected, the method can create an artificially-generated “ordered” point cloud by ray-tracing from the scanner position into the 3D model for each point in the ordered point cloud. Since the points of the ordered point cloud are arranged on a uniform grid, then specifying a row and column index will uniquely specify a direction/orientation from the center of the scan-position. At a next step, 208, the method performs a ray trace the center of the scan position along the direction/orientation. That is, a ray may be traced from the scanner's position along this direction, which terminates when the ray hits the nearest triangle in the mesh. The result of these steps is a point cloud of arbitrary density that is aligned to the generated triangulated 3D mesh. The density of the output point cloud may be adjusted by just sampling at smaller intervals along the rows and columns. For example, FIG. 3 is an illustrative representation of a low density point cloud generated utilizing methods in accordance with embodiments of the present invention.

At a next step 210, the method colors the point. A step 210 corresponds with at least three sub-steps 212 to 218. At a step 212, the methods selects all images temporally proximate with the scan position. As noted above, multiple cameras may be utilized to generate a local point cloud that has information at every angle. Likewise, multiple images may be utilized to gather color information. At a next step 214, the method determines the 3D world position/orientation of the cameras associated with the selected images. Using this 3D world position/orientation, the method, at a step 216, projects the ray traced point onto the image plane of the camera for each selected image thereby selecting a corresponding point on the image plane of the camera. At a next step 218, the method selects the nearest color of the projected ray traced point from the selected image. Since there are multiple images each having a ray traced point, colors between images may differ. In those cases, a weighted averaging may be used to determine the color, based on how “centered” the point is in each camera's field of view. In cases where the colors are the substantially similar, the color is selected.

At a next step 220, the method returns a colored point cloud aligned to the triangulated 3D mesh. It may be appreciated that steps aligning (step 202) and coloring (step 210) the points may be iteratively performed until a specified density is achieved. For example output is represented in FIG. 4, which is an illustrative representation of a high density point cloud utilizing methods in accordance with embodiments of the present invention. As may be seen, the final output is an ordered point cloud with color centered at a position where imagery was captured by the mobile scanner. This process may be repeated at different locations in the model to create a set of ordered point clouds that cover the scanned area. This result emulates the effect of having scanned the building with a sequence of static scanners, but with the speed of a mobile scanner. In another example, FIG. 3 is an illustrative representation of a low density point cloud generated utilizing methods in accordance with embodiments of the present invention.

In one embodiment, a point cloud may be generated from an image captured by a mobile image capture device such as a smart phone or digital camera. In those embodiments, the image captured may be compared with images captured from the initial building scan. If a matching image is found, the methods may be employed to generate an ordered point cloud for that position. Thus, a user may leverage computational resources with a light weight mobile device.

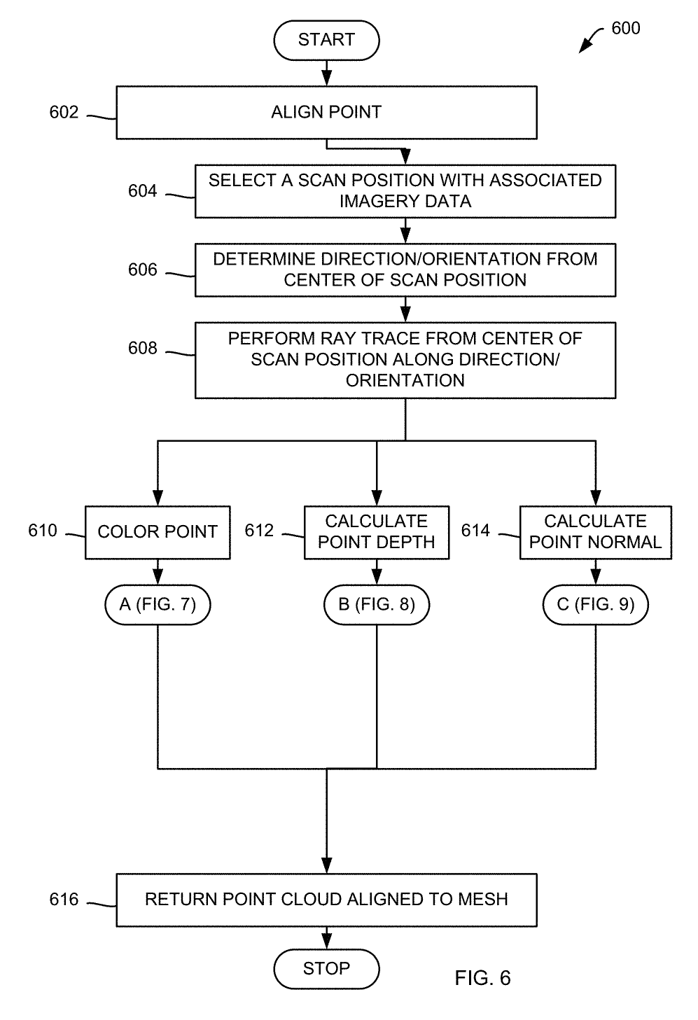

FIG. 6 is an illustrative flowchart 600 of methods for generating an aligning and coloring a point in a point cloud using a mobile scanner data in accordance with embodiments of the present invention. In particular, FIG. 6 further describes a step 106 of FIG. 1. At a first step 602, the methods aligns a plurality of scanned points with the mesh generated. A step 602 corresponds with at least three sub-steps 604 to 608. At a step 604, the method selects a scan position having associated imagery data. Utilizing methods disclosed herein, the scan position selected must have imagery data associated with it. A mobile scanning system generally includes several cameras with each camera capturing images substantially continuously or at some pre-determined interval. When a scan position at which to generate a local ordered point cloud is selected, images that are temporally proximate with the scan position from each of a number of cameras on the mobile scanning device are selected for analysis. For example, one system includes several cameras having different views namely: back, left, right, front, top. One reason for using multiple cameras is to generate a local point cloud that has information at every angle. Thus, all cameras available may be utilized for each scan position. In other embodiments, it may be possible to only use a subset of the cameras, but this would mean that there would be areas of the resulting point cloud that are uncolored. In embodiments, these cameras may be configured to capture images at substantially the same time although actual images may be captured a few milliseconds apart. For a selected scan position, the method may include at least five images: a nearest in time back-camera image, a nearest in time right-camera image, a nearest in time left-camera image, a nearest in time front-camera image, and a nearest in time top-camera image. In practice, a scan position represents a point along the building walkthrough. A timestamp is determined for that point. The images from each camera nearest to that timestamp are selected so that the resulting merged image is consistent. It may be desirable to select images taken as close together in time as possible since a scene might change over time (people walking by, doors opening, etc.).

At a next step 606, the method determines the direction/orientation from the center of the scan position. Using the generated 3D mesh, the method can create an artificially-generated “ordered” point cloud by ray-tracing from the scanner position into the 3D model for each point in the ordered point cloud. Since the points of the ordered point cloud are arranged on a uniform grid, then specifying a row and column index will uniquely specify a direction/orientation from the center of the scan-position. At a next step, 608, the method performs a ray trace the center of the scan position along the direction/orientation. That is, a ray may be traced from the scanner's position along this direction, which terminates when the ray hits the nearest triangle in the mesh. The intersection point between the ray and the mesh is a 3D location of a point in the ‘ordered point cloud’. The result of these steps is a point cloud of arbitrary density that is aligned to the generated triangulated 3D mesh. The density of the output point cloud may be adjusted by just sampling at smaller intervals along the rows and columns. For example, FIG. 3 is an illustrative representation of a low density point cloud generated utilizing methods in accordance with embodiments of the present invention.

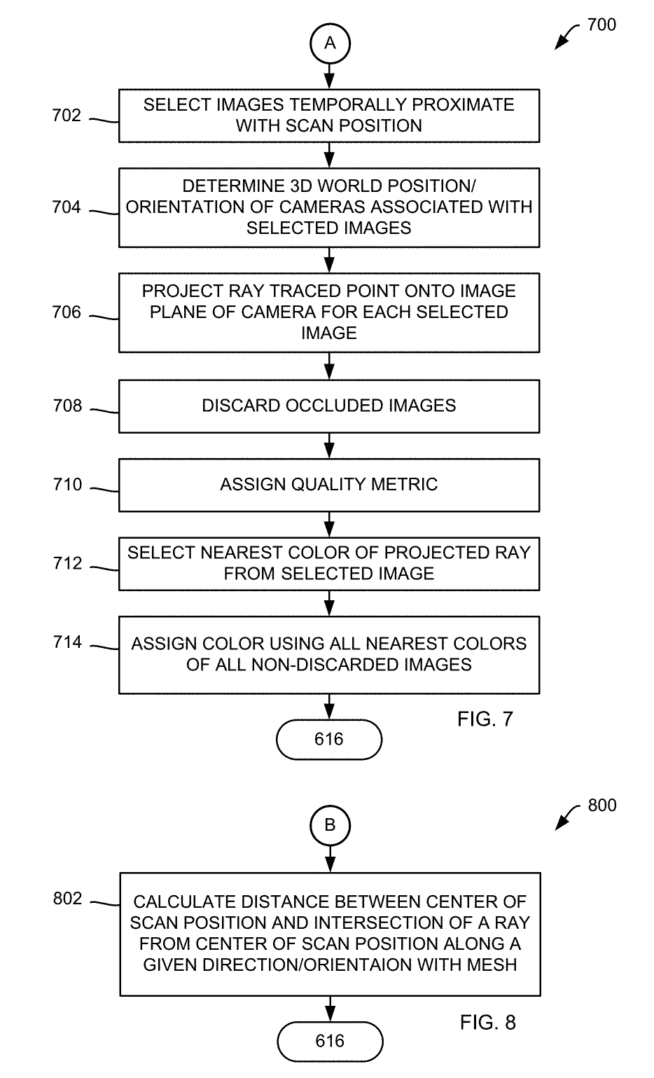

Steps 610, 612, and 614 represent parallel paths of processing that calculate point attributes such as coloring each scanned point in step 610, finding the depth of each scanned point in step 612 and finding the normal of each scanned point in step 614. It may be appreciated that the term “parallel” should not be construed to require that the steps being performed at the same time in parallel processing, rather that these steps may be performed in any order including parallel or serially. The term “parallel” is intended to convey that the steps are not required in any particular order, but each must be performed before the following step (as in a step 616). These steps will be discussed in further detail below for FIGS. 7-9 respectively.

At a next step 616, the method returns a colored point cloud aligned to the triangulated 3D mesh. It may be appreciated that steps aligning (step 202) and coloring (steps 210 610, 612, and 614) the points may be iteratively performed until a specified density is achieved. For example output is represented in FIG. 4, which is an illustrative representation of a high density point cloud utilizing methods in accordance with embodiments of the present invention. As may be seen, the final output is an ordered point cloud with color centered at a position where imagery was captured by the mobile scanner. This process may be repeated at different locations in the model to create a set of ordered point clouds that cover the scanned area. This result emulates the effect of having scanned the building with a sequence of static scanners, but with the speed of a mobile scanner. In another example, FIG. 3 is an illustrative representation of a low density point cloud generated utilizing methods in accordance with embodiments of the present invention.

In one embodiment, a point cloud may be generated from an image captured by a mobile image capture device such as a smart phone or digital camera. In those embodiments, the image captured may be compared with images captured from the initial building scan. If a matching image is found, the methods may be employed to generate an ordered point cloud for that position. Thus, a user may leverage computational resources with a light weight mobile device.

FIG. 7 is an illustrative flowchart of methods for assigning a color to 3D point in accordance with embodiments of the present invention. In particular, FIG. 7 represents further detail for a step 610 (FIG. 6). At a step 702, the methods selects all images temporally proximate with the scan position. As noted above, multiple cameras may be utilized to generate a local point cloud that has information at every angle. Likewise, multiple images may be utilized to gather color information. At a next step 704, the method determines the 3D world position/orientation of the cameras associated with the selected images. Using this 3D world position/orientation, the method, at a step 706, projects the ray traced point onto the image plane of the camera for each selected image thereby selecting a corresponding point on the image plane of the camera. At a next step 708, the method tests whether a point at an image plane is occluded and if so, the point at the image plane is disqualified from coloring the ray traced 3D point in the ‘ordered cloud.’ In this step, the same ray is traced from the 3D world position on the camera back to the mesh and a new 3D point is computed as an intersection point. When there exists a line of sight between the 3D point in the ‘ordered cloud’ and the camera, the two points coincide. If, on the other hand, the distance between the two 3D points is not identical, the 3D point in the ordered point cloud is occluded and the point at the image plane of the camera is disqualified from coloring it.

When choosing a 3D point color among the multitude of images that have pixels associated with the 3D point, a combined quality metric may be used to aid the process. A quality metric of a pixel is a combination of multiple factors such that the overall metric is (a) inversely proportional to the pixel distortion (a pixel proximity to the principal axis of its camera), (b) inversely proportional to an amount of pixel blur, (c) inversely proportional to operator velocity at the time of image taking, (d) inversely proportional to a point distance to camera. Such quality metric can further be used in deciding the best image to color a 3D point among the multitude of images that have pixels the 3D point back projects into. Thus, at a next step 710, the method assigns a quality to a point at the image plane to the camera. In embodiments, the quality metric may be, but not limited, to a product of e.g. cosine square of an angle between the ray and the principal axis of the camera, exponential function of negative velocity a the time of image taking and exponential function of negative distance of a 3D point and the camera center.

At a next step 712, the method selects the nearest color of the projected ray traced point from the selected images, along with its associated quality. Since there are multiple images each having a ray traced point, colors between images may differ. At a next step 714, the method assigns color using all nearest colors of all non-discarded images. In those cases, as described by the step 714, a weighted averaging may be used to determine the color, based on the “quality” of the point is in each camera's field of view. In cases where the colors are the substantially similar, the color is selected. The method then continues to a step 616 (FIG. 6).

FIG. 8 is an illustrative flowchart 800 of methods for assigning a distance from a 3D point to the scan center location in accordance with embodiments of the present invention. In particular, FIG. 8 represents further detail for a step 612 (FIG. 6). As noted above, in addition to color, each point in 3D cloud is assigned additional attributes. Thus, at a step 802, the method calculates a distance between center of scan position and an intersection of a ray from the center of the can position along a given direction/orientation with the mesh. That is, depth is calculated as a distance from the scan center and the 3D point. The method then continues to a step 616 (FIG. 6).

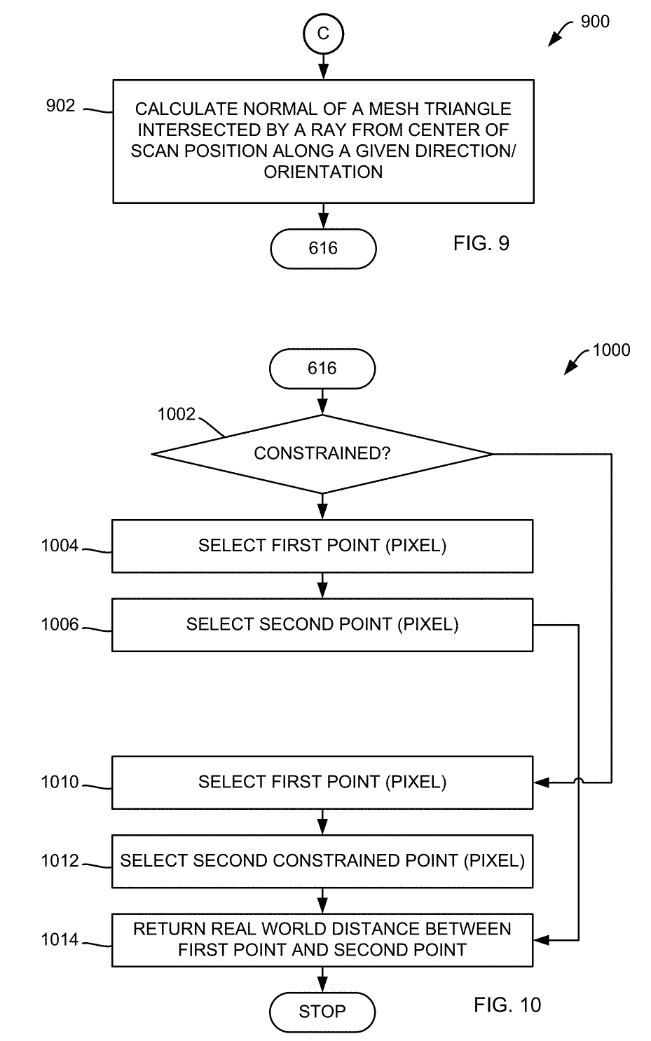

FIG. 9 is an illustrative flowchart 900 of methods for assigning a surface normal to a 3D point in accordance with embodiments of the present invention. In particular, FIG. 9 represents further detail for a step 614 (FIG. 6). As noted above, in addition to color, each point in 3D cloud is assigned additional attributes. Thus, at a step 802, the method calculates normal of a mesh triangle intersected by a ray from the center of the scan position along a given direction/orientation. That is, a point normal is calculated as normal of the intersecting mesh triangle. The method then continues to a step 616 (FIG. 6).

FIG. 10 is an illustrative flowchart 1000 of methods for making real-world 3D measurement from 360° panoramic image associated with an ordered point cloud in accordance with embodiments of the present invention. In an embodiment, the ordered point cloud associated with attributes such as color, depth and normal may be used for enabling photographic virtual tours of a scanned space and 3D measurements. The ordered point cloud is transformed to a set of 360° panoramic images including: a color image, a depth image and a normal image. A user is presented with the color panoramic image. In step 1002 the method determines whether the desired measurement is a free measurement or a constrained measurement. If the method determines at a step 1002 that the desired measurement is a free measurement, the method continues to step 1004. If the method determines at a step 1002 that the desired measurement is a constrained measurement, the method continues to step 1010. A free measurement, as described in steps 1004, 1006 and 1008, measures a distance between any two points on an object. A constrained measurement, as described in steps 1010, 1012 and 1014, measures a distance between two points on an object may be constrained along e.g. vertical, horizontal or any other predefined axis. At a step 1004, the user selects any point (pixel) of an object seen in the panoramic image. Likewise at a step 1006, the user selects any point (pixel) of an object seen in the panoramic image. The method continues to a step 1014 to select two corresponding points in the depth image and along with the scan center information calculates real world distance. For a constrained measurement, a user selects the first point (pixel), as in a step 1010. Using the information from the depth image, and the normal image, a computer mouse movement is constrained within predefined axis. A user selects a constrained second point (pixel) as in a step 1012. The method continues to a step 1014 to select two corresponding points in the depth image and along with the scan center information calculates real world distance.

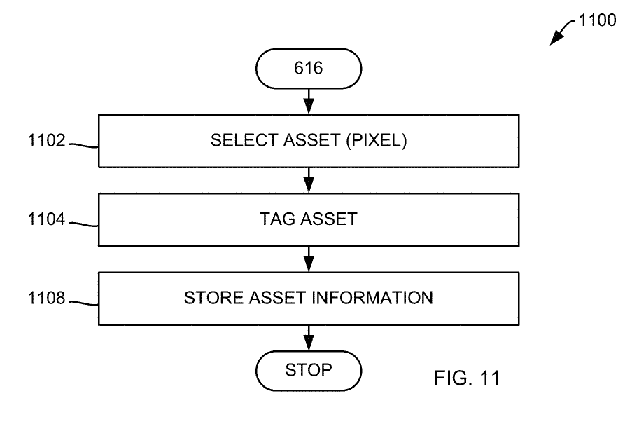

FIG. 11 is an illustrative flowchart 1100 of methods for asset tagging in all color panoramic images associated with ordered point clouds. In an embodiment, the set of ordered point clouds transformed to a photographic virtual tour may be used for asset tagging. As such, at a step 1102, an asset is tagged by clicking a point in one color panoramic image associated with one ordered point cloud. In a next step 1104, a point 3D position is calculated and automatically tagged in all other color panoramic images. This process involves calculating a 3D point associated with a pixel in a given panoramic image using depth image and the scan center of the given panoramic image. The 3D point is then ray traced toward a scan center location associated with a target panoramic image and intersection pixel is found. However, the asset may be occluded in the target panoramic image. The occlusion check may be performed by calculating the distance from the 3D asset point to the target scan center and comparing it with the depth information of the intersected pixel in the target panoramic image. If the two coincide the 3D asset is not occluded and the asset is tagged in the target panoramic image. The intersecting pixels in all target images may be pre-computed and stored in a data base, or they may be calculated on demand, when a user “walks to” a particular panoramic image. Finally, in a step 1108, an asset's 3D information along with other text, audio or visual notes is stored in a database. Such 3D annotation database can then be viewed in 3D or in a virtual walk-through. Thus, a user tags an object once, but sees it in all panoramic images that contain it during the virtual walk-through.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

While this invention has been described in terms of several embodiments, there are alterations, permutations, and equivalents, which fall within the scope of this invention. It should also be noted that there are many alternative ways of implementing the methods, computer program products, and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A method for generating a set of ordered point clouds using a mobile scanning device, the method comprising:
causing the mobile scanning device to perform a walkthrough scan of an interior building space;
storing data scanned during the walkthrough;
creating a 3-dimensional (3D) mesh from the scanned data; and
creating the set of ordered point clouds aligned to the 3D mesh, wherein the creating the set of ordered point clouds aligned to the 3D mesh comprises,
aligning a plurality of scanned points with the 3D mesh,
performing in parallel the steps of,
coloring each of a plurality of scanned points,
calculating a depth of each of the plurality of scanned points, and
calculating a normal of each of the plurality of scanned points.

2. The method of claim 1, wherein the mobile scanning device captures one or more of the following: a plurality of images from a plurality of camera positions, pose and orientation information associated with each of the plurality of images captured, and magnetic data information associated with each of the plurality of images captured.

3. The method of claim 1, wherein the 3D mesh is a watertight triangulated 3D mesh.

4. The method of claim 1, further comprising:
continuing to iteratively perform the steps of aligning, coloring, calculating the depth, and calculating the normal of the plurality of scanned points until a specified density is achieved.

5. The method of claim 1, wherein the aligning the plurality of scanned points with the 3D mesh further comprises:
selecting a scan position having associated imagery data corresponding with the scanned data;
determining a direction/orientation from a center of the scan position; and
performing a ray trace to the point from the center of the scan position along the direction/orientation.

6. The method of claim 5, further comprising:
selecting a plurality of images temporally proximate with the scan position from each of a plurality of cameras for analysis, wherein the plurality of cameras each have different views.

7. The method of claim 1, wherein the coloring the plurality of scanned points further comprises:
selecting a plurality of images temporally proximate with the scan position;
determining a 3D world position/orientation of a cameras associated with the selected images;
projecting the ray traced point onto an image plane of the camera for each of the selected images;
discarding any occluded images;
assigning a quality metric to a point in the image plane of the camera;
selecting a nearest color of the projected ray traced point from the selected images; and
assigning all nearest colors of all non-discarded images.

8. The method of claim 7, wherein assigning the selected color further comprises:
if the nearest color from each of the plurality of are substantially similar, selecting the color; and
if the nearest color from each of the plurality of are different, computing a weighted average of the colors and selecting the color from the weighted average.

9. The method of claim 7, wherein the quality metric is combination of factors selected from the group consisting of: a factor inversely proportional to the pixel distortion, a factor inversely proportional to an amount of pixel blur, a factor inversely proportional to operator velocity at the time of image taking, and a factor inversely proportional to a point distance to camera.

10. A computing device program product for generating a set of ordered point clouds using a mobile scanning device, the computing device program product comprising:
a non-transitory computer readable medium;
first programmatic instructions for storing data scanned during a walkthrough scan of an interior building space;
second programmatic instructions for creating a 3D mesh from the scanned data; and
third programmatic instructions for creating the set of ordered point clouds aligned to the 3D mesh, wherein the third programmatic instructions comprise,
aligning a plurality of scanned points with the 3D mesh,
performing in parallel the steps of,
coloring each of a plurality of scanned points,
calculating a depth of each of the plurality of scanned points, and
calculating a normal of each of the plurality of scanned points, and wherein
the programmatic instructions are stored on the non-transitory computer readable medium.

11. The computing device of claim 10, wherein the mobile scanning device captures one or more of the following: a plurality of images from a plurality of camera positions, pose and orientation information associated with each of the plurality of images captured, and magnetic data information associated with each of the plurality of images captured.

12. The computing device of claim 10, wherein the 3D mesh is a watertight triangulated 3D mesh.

13. The computing device of claim 10, wherein the creating the third programmatic instructions for creating the set of ordered point clouds aligned to the 3D mesh further comprises:
fourth programmatic instructions for aligning a plurality of scanned points with the 3D mesh; and
fifth programmatic instructions for coloring the plurality of scanned points.

14. The computing device of claim 13, further comprising:
sixth programmatic instructions for continuing to iteratively perform the steps of aligning and coloring the plurality of scanned points for a plurality of points until a specified density is achieved.

15. The computing device of claim 13, wherein the fourth programmatic instructions for aligning the plurality of scanned points with the 3D mesh further comprises:
seventh programmatic instructions for selecting a scan position having associated imagery data corresponding with the scanned data;
eighth programmatic instructions for determining a direction/orientation from a center of the scan position; and
ninth programmatic instructions for performing a ray trace to the point from the center of the scan position along the direction/orientation.

16. The computing device of claim 15, further comprising:
tenth programmatic instructions for selecting a plurality of images temporally proximate with the scan position from each of a plurality of cameras for analysis, wherein the plurality of cameras each have different views.

17. The computing device of claim 13, wherein the fifth programmatic instructions for coloring the plurality of scanned points further comprises:
eleventh programmatic instructions for selecting a plurality of images temporally proximate with the scan position;
twelfth programmatic instructions for determining a 3D world position/orientation of a cameras associated with the selected images;
thirteenth programmatic instructions for projecting the ray traced point onto an image plane of the camera for each of the selected images;
fourteenth programmatic instructions for discarding any occluded images;
fifteenth programmatic instructions for assigning a quality metric to a point in the image plane of the camera;
sixteenth programmatic instructions for selecting a nearest color of the projected ray traced point from the selected images; and
seventeenth programmatic instructions for assigning all nearest colors of all non-discarded images.

18. The computing device of claim 17, wherein fifteenth programmatic instructions for assigning the selected color further comprises:
if the nearest color from each of the plurality of are substantially similar, sixteenth programmatic instructions for selecting the color
if the nearest color from each of the plurality of are different, seventeenth programmatic instructions for computing a weighted average of the colors and selecting the color from the weighted average.
